(19) United States
(12) Patent Application Publication
(10) Pub. No.: US 2016/0222200 A1
(43) Pub. Date: Aug. 4, 2016

(54) Green Reinforced Composite Materials

(71) Applicant: H. J. HEINZ COMPANY, Pittsburgh, PA (US)

(72) Inventors: Vidhu Nagpal, Mars, PA (US); Michael Okoroafor, Gibsonia, PA (US)

(21) Appl. No.: 15/021,009

(22) PCT Filed: Sep. 10, 2014
(86) PCT No.: PCT/US2014/054910

§ 371 Date: Mar. 10, 2016

Related U.S. Application Data
(60) Provisional application No. 61/876,446, filed on Sep. 11, 2013.

(51) Int. Cl. C08L 23/12

(52) U.S. Cl. CPC C08L 23/12

(57) ABSTRACT

Tomato and/or potato waste particle, flake and/or fiber reinforced composite material. Factory waste material from tomato or potato processing is dried, ground, optionally treated with a coupling agent and blended with a matrix material to form composite material.

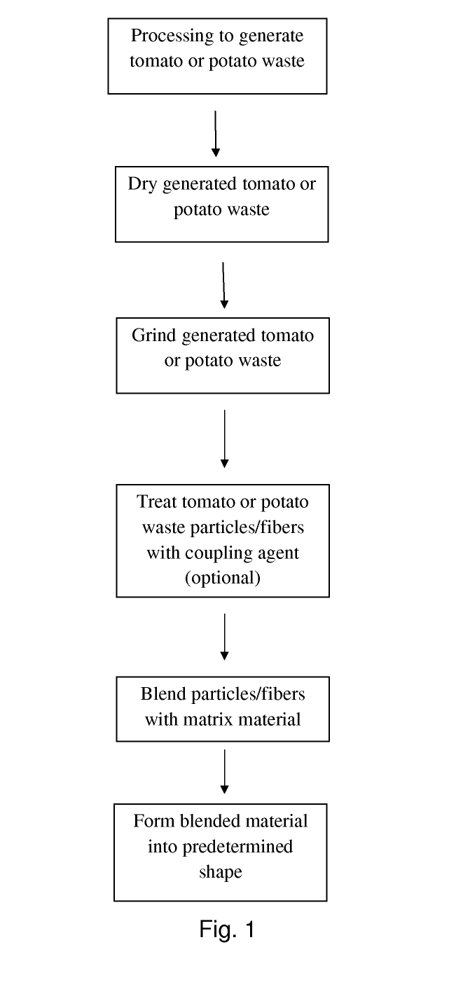

### CROSS-REFERENCE TO RELATED APPLICATIONS

This application claims priority to U.S. Provisional Application No. 61/876,446, filed Sep. 11, 2013, the disclosure of which is hereby expressly incorporated by reference herein in its entirety.

### TECHNICAL FIELD

The field of art to which this invention generally pertains is reinforced matrix composite materials and methods of making the same.

### BACKGROUND

It is well known to improve the properties of composite materials by adding fiber reinforcement. See, for example, U.S. Pat. Nos. 5,595,696; 5,709,933; 5,776,281; 5,869,173; 6,939,903; 7,716,880; and 8,080,288, the disclosures of which are herein incorporated by reference. In order for such materials to be useful commercially, cost of materials is a significant consideration. To the extent that synthetic materials are useful in formulating such composite materials, there is not only the added cost associated with the production of these materials, but environmental considerations to take into account as well.

The present invention attempts to address the challenges described above, in addition to the introduction of novel “green” (i.e., more environmentally friendly) materials useful for these purposes.

### BRIEF SUMMARY

A composite material is described made up of a matrix material reinforced with potato and/or tomato waste particulate material repurposed from factory waste.

Embodiments of the invention include: the composite material described above where the matrix is a polymer material; the composite material described above where the matrix material is a polyethylene and/or polypropylene polymer; the composite material described above where the particulate material is in the form of fibers, particles, flakes, or mixtures thereof; the composite material described above, where the particulate material has a size less than 5 millimeters; the composite material described above where the particulate material has a size less than 2 millimeters; the composite material described above where the potato waste is potato skins; the composite material described above where the tomato waste is tomato pomace; the composite material described above in the form of food packaging; the composite material described above where the food packaging is in the form of a meal tray, packaging closure, rigid container, or flexible film.

A method of making a composite material is also described. Tomato and/or potato waste reinforcing particulate material is dried, ground and blended with a matrix material, and the blended material is formed into predetermined shape.

Additional embodiments include the method described above where the particulate material is treated with a coupling agent after drying and grinding; the method described above where the matrix material is a polymer material; the method described above where the matrix material is a polyethylene and/or polypropylene polymer; the method described above where the particulate material is in the form of fibers, particles, or mixtures thereof; the method described above where the particulate material has a size less than 5 millimeters; the method described above where the particulate material has a size less than 2 millimeters; the method described above where the potato waste is potato skins; the method described above where the tomato waste is tomato pomace.

These, and additional embodiments, will be apparent from the following descriptions.

### BRIEF DESCRIPTION OF THE DRAWINGS

The FIGURE shows one process flow chart embodiment described herein.

### DETAILED DESCRIPTION

The particulars shown herein are by way of example and for purposes of illustrative discussion of the various embodiments of the present invention only and are presented in the cause of providing what is believed to be the most useful and readily understood description of the principles and conceptual aspects of the invention. In this regard, no attempt is made to show details of the invention in more detail than is necessary for a fundamental understanding of the invention, the description making apparent to those skilled in the art how the several forms of the invention may be embodied in practice.

The present invention will now be described by reference to more detailed embodiments. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise. All publications, patent applications, patents, and other references mentioned herein are expressly incorporated by reference in their entirety.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Every numerical range given throughout this specification will include every narrower numerical range that falls within such broader numerical range, as if such narrower numerical ranges were all expressly written herein.

Additional advantages of the invention will be set forth in part in the description which follows, and in part will be obvious from the description, or may be learned by practice of the invention. It is to be understood that both the foregoing general description and the following detailed description are exemplary and explanatory only and are not restrictive of the invention, as claimed.

The matrix material useful with the present invention can be any matrix material typically used in making composite materials, and especially natural and synthetic rubbers and thermoplastic and thermosetting polymers. While not being limited to any particular polymers, examples include commercially available plastics such as epoxy based polymers, polyurethane ureas, isocyanate based polymers, and other cross-linkable materials, polyolefins, styrene polymers, polyamides, saturated polyesters, polycarbonates, polyetherimides, polyether ketones and polyether sulfones, graft copolymers, for example with acrylic materials, acrylonitrile-butadiene-styrene copolymers, polytetrafluoroethylene, polycarbonate, high-density polyethylene, low-density polyethylene, polypropylene, polyurethane, polyethylene terephthalate, poly-butylene terephthalate, polyvinyl chloride, polyetherketone, polyphenylene oxide, polyetherimide, polyphenylene sulfide, and mixtures thereof, to name just a few.

The filled composite materials may also contain conventional additives depending on the intended use of the composite material, such as, for example, colorants, stabilizers, fillers, dyes, flame-proofing agents, pigments, conventional fillers such as calcium carbonate for hardness, ultraviolet light stabilizers, heat stabilizers, antioxidants, fungicides and adhesion promoters, present in amounts conventionally used to achieve their intended purpose, e.g., up to 50% by weight, and typically 20% or more, e.g., up to 40% by weight. As much additive as desired can be added, as long as the polymer properties that are useful for the intended use, e.g., packaging, are retained.

Particularly useful additives are conventional coupling/wetting agents such as polypropylene graft maleic anhydride, chromium complexes, titanates, zirconim aluminates, and silanes such as organosilanes, aminosilanes, epoxysilanes, alkoxysilanes, methacrylic silanes, mercaptosilanes, chlorosilanes, and oligomers, mixtures, and blends thereof. These additives are typically present in an any amount required to attain their intended purpose, and typically up to about 20% by weight. They can improve mixing and wetting of the particulate material in the matrix as well. Also, the particles are typically mixed or blended with the additives prior to mixing or blending with the polymers.

While any amount of reinforcing particles, flakes or fibers can be used in the matrix depending on the ultimate use of the composite material and the properties of the composite desired, i.e., strength, flexibility, etc., typically the reinforcing particles and/or fibers are present, by weight, in an amount up to about 35%, more typically about 15% to about 25%, and most typically about 20%.

The particulate material used in the composite material is that material left over after typical potato or tomato processing during manufacturing operations. In the case of tomatoes, it is the waste material remaining after processing tomatoes for juice, ketchup, soup, etc. After processing to extract juice and pulp from tomatoes, tomato pomace—primarily water, seeds and peels—is left behind. The waste generated during food processing in the factory is very different from, e.g., agricultural waste like wheat straw and rice process waste, which is generated at the field typically during harvesting operation. The water content of pomace is typically well over 50% so in most cases the water will be removed prior to being used with the matrix material, depending on the compatibility of the matrix material with water, for example. The water is removed in conventional fashion utilizing conventional centrifuge or rotary drum or other standard and conventional drying equipment (e.g., note U.S. Pat. Nos. 1,402,136; 3,172,770; and 4,670,281, the disclosures of which are herein incorporated by reference). While conventional natural gas or electricity drying can be used, as an environmental friendly alternative, sun drying can be used as well. The fibers, flakes and/or particles are typically dried until they are dry to the touch, i.e., so they flow freely between the fingers and hands, e.g., less than 10% by weight moisture content. The resulting material is then ground or broken up using conventional particle grinders to any particle size desired, depending on the matrix used and the intended use of the composite material. While the material can be used in either particle or fiber form, the material is typically used as a uniform mixture of particles and fibers, having size less than 5 millimeters (mm), and preferable less than 2 mm.

The potato waste is typically in the form of potato skins remaining from conventional potato processing (see, e.g., U.S. Pat. Nos. RE 29,030 and 3,480,057 the disclosures of which are herein incorporated by reference). For example, in conventional potato processing the potatoes are typically tumbled in an apparatus which provides a combined abrasion and cutting action that removes the loosened (typically with steam or lye) skins as a relatively dry sludge or paste-like material which is typically removed by a take-away conveyor running beneath the peeler. The peeler typically removes about 85-90 percent of the skins from the potatoes. The thus peeled potatoes are then typically subjected to a brush clean up device where the skin portions not previously removed (usually located at the eyes of the potato) are finally removed. The thus processed skins are then dried and ground in conventional fashion utilizing the same equipment and processes, to the same drying levels and particle and fiber sizes described above for the tomato waste.

Although not required, to impart stronger properties into the resulting composite, the dried, ground reinforcing particles and/or fibers are typically combined with a compatibilizer or coupling agent, as described above (see also, e.g., U.S. Pat. No. 5,187,018, the disclosure of which is herein incorporated by reference). The matrix material is then blended with the reinforcing particles or fibers in a conventional mixer, and molded or otherwise formed into the intended shape in conventional fashion.

In general the conventional molding methods used to process the particle or fiber reinforced matrix material of the present invention will include heating the material to a temperature which will allow it to flow into the desired shape, introducing the heated material into the mold, allowing it to cool, and removing the shaped article. A liquid carrier (such as water or organic solvent) solution or dispersion of the material can also be introduced into the mold and the mold heated to drive off the liquid. Other conventional methods which can be used include injection molding, blow molding, compression molding, thermoforming, etc.

### EXAMPLE

A dried, ground, tomato waste fiber and particle mixture were blended with a polypropylene resin at 20 by weight % using a maleic anhydride compatibilizer and introduced into a shaped mold. The blend in the mold was allowed to cool to room temperature, removed from the mold and tested for mechanical properties using conventional ASTM methods and testing apparatus. The results are shown below in the Table (MPa=megaPascal; GPa=gigaPascal):

TABLE

| | Young's Modulus | Flex Modulus | Flex Strength |
|---|---|---|---|
| Sample | (MPa) | (GPa) | (MPa) |
| Polypropylene (PP) | 1488 | 0.95 | 34 |
| 20% tomato waste | 1684 | 1.24 | 40 |
| fiber filled PP | | | |

As can be seen from the Table, the mechanical properties of tomato waste fiber reinforced polypropylene improved significantly (13%, 31% and 18% improvement respectively) over the unfilled resin. These results clearly show that the use of tomato waste particles and fiber is a valuable reinforcing material for composite applications, helpful to the environment not only in reducing the amount of resin needed, potentially replacing non-natural reinforcing materials, improving the properties of the reinforced material, but also provides an extremely useful application for the large volumes of waste generated from commercial tomato processing which could otherwise end up as land fill.

The composite material described herein can be used wherever reinforced matrix materials are conventionally used, e.g., food packaging such as meal trays, closures (such as bottle/container cap or lid), rigid containers, flexible films, interior and other automotive parts, etc. It is particularly useful in the food packaging area as an environmentally friendly alternative to packaging material typically used for that purpose, e.g., allowing less petroleum based plastics to be used, in addition to the benefits of using a natural filler obtained from natural food processing. See also commonly assigned U.S. Pat. No. 8,445,088, the disclosure of which is incorporated by reference herein.

Thus, the scope of the invention shall include all modifications and variations that may fall within the scope of the attached claims. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A composite material comprising
a matrix material reinforced with tomato waste particulate material repurposed from factory waste.

2. The composite material of claim 1, wherein the matrix comprises polymer material.

3. The composite material of claim 1, wherein the matrix comprises at least one of polyethylene and polypropylene polymer.

4. The composite material of claim 1, wherein the particulate material comprises fibers, flakes, particles, or mixtures thereof.

5. The composite material of claim 1, wherein the particulate material has a size less than 5 millimeters.

6. The composite material of claim 1, wherein the particulate material has a size less than 2 millimeters.

7. (canceled)

8. The composite material of claim 1, wherein the tomato waste is tomato pomace.

9. The composite material of claim 1, in the form of food packaging.

10. The composite material of claim 9, wherein the food packaging comprises at least one of a meal tray, packaging closure, rigid container, or flexible film.

11. A method of making a composite material comprising:
drying and grinding tomato waste reinforcing particulate material,
blending the dried and ground particulate material with a matrix material, and
forming the blended material into predetermined shape.

12. The method of claim 11, wherein the particulate material is treated with a coupling agent after drying and grinding.

13. The method of claim 11, wherein the matrix material is a polymer material.

14. The method of claim 11, wherein the matrix material comprises at least one of a polyethylene and polypropylene polymer.

15. The method of claim 11, wherein the particulate material comprises fibers, flakes, particles, or mixtures thereof.

16. The method of claim 11, wherein the particulate material has a size less than 5 millimeters.

17. The method of claim 11, wherein the particulate material has a size less than 2 millimeters.

18. (canceled)

19. The method of claim 11, wherein the tomato waste is tomato pomace.
